(19) United States
(12) Patent Application Publication
(10) Pub. No.: US 2011/0219219 A1
(43) Pub. Date: Sep. 8, 2011

(54) SEMICONDUCTOR INTEGRATED CIRCUIT AND REGISTER ADDRESS CONTROLLER

(75) Inventors: Yuusuke ADACHI, Osaka (JP); Eiji Nagata, Osaka (JP)

(73) Assignee: PANASONIC CORPORATION, Osaka (JP)

(21) Appl. No.: 13/110,664

(22) Filed: May 18, 2011

Related U.S. Application Data
(63) Continuation of application No. PCT/JP2009/005614, filed on Oct. 23, 2009.

(30) Foreign Application Priority Data
Nov. 18, 2008 (JP) P2008-294310

(51) Int. Cl. G06F 9/30

(52) U.S. Cl. 712/229; 712/E09.023

(57) ABSTRACT

This invention provides with a semiconductor integrated circuit, comprising a register map that makes correspondence between a register to which a CPU accesses and an address which specifies the register, wherein the register map includes a plurality of register maps in which assignments of address bits are rearranged in correspondence with each of a plurality of modes, and wherein any of the register maps is selected from the plurality of register maps according to the respective modes.

### BACKGROUND OF THE INVENTION

1. Field of the Invention

The present invention relates to a semiconductor integrated circuit and a register address controller intended for a CPU to make an access to a register of a periphery circuit of the CPU.

2. Background Art

Signals, like an address signal, a data signal, and a control signal, are usually sent from a CPU to a peripheral circuit controlled by the CPU by a bus. The peripheral circuit has a register for storing information represented by the signals and operates according to information recorded in the register. An address to be managed by an address signal is assigned to the register and managed as is memory.

Patent Document 1 describes a semiconductor integrated circuit that outputs a chip select signal in response to an address signal from a CPU, thereby making a predetermined memory chip effective. A plurality of addresses that are stored in a register, are compared with an address sent from the CPU. A comparison result is then subjected to enable or disable control. A chip select signal is generated, according to the comparison result and the control result of enable or disable. Whereby an address space to which a memory chip is assigned can be arbitrarily selected.

### SUMMARY OF THE INVENTION

When a semiconductor integrated circuit is newly designed, not all circuits are newly designed. A new semiconductor circuit is designed in many cases by diversion of existing semiconductor integrated circuits. In this regard, a peripheral circuit is also diverted likewise. When there is a functional addition or correction, and the like, it may be the case that the thus-added or corrected function cannot be assigned to the same address at that of the existing semiconductor integrated circuit that is a source of diversion. As a consequence, software produced for the existing semiconductor integrated circuit cannot be used for a newly designed semiconductor integrated circuit.

Further, for instance, when a different control function is assigned on a per-bit basis to a register having an 8-bit width, respective bits of a register specified by a single address are simultaneously subjected to manipulations like alterations or updates. For this reason, in order to operate an arbitrarily one bit, a value of a register is once read, and a value determined by adding an alteration solely to a bit that is desired to be controlled must be written into the register.

However, in a system controlled by a multitask or a multiprocessor, there is no guarantee that an access to read a register value for one task and an access to write the register for the same task will inevitably become sequential. Therefore, exclusiveness of an access must be assured by use of software resource management means, like semaphore. As a consequence, processing performance of a CPU is sacrificed, so that a software design becomes complicate.

Patent Document 1: JP-A-6-28243

An objective of the present invention is to provide a semiconductor integrated circuit and a register address controller that enable use of software produced by an existing semiconductor integrated circuit even when functional additions and corrections are made to the existing semiconductor integrated circuit and that enable enhancement of CPU performance.

The present invention provides a semiconductor integrated circuit comprising a register map that makes correspondence between a register to which a CPU accesses and an address specifying the register, wherein the register map includes a plurality of register maps in which assignments of address bits are rearranged in correspondence with each of a plurality of modes; and wherein a register map is selected from the plurality of register maps according to the respective modes.

In the semiconductor integrated circuit, the plurality of register maps are arranged respectively in different address spaces, and the plurality of register maps are simultaneously used.

In the semiconductor integrated circuit, an initial value of address information and an initial value of bit information are set on each of the plurality of modes, and the register map is switched according to initial values of the respective modes.

The present invention provides a register address controller comprising a register where address information is to be set; and an address information setting unit configured to set the address information on the register.

The register address controller includes a starting address setting unit configured to set a starting address of the address information on the register.

In the register address controller, the register is provided in numbers, and a first status register that determines whether or not an address of a first register that is set by the address information setting unit overlaps an address set on another register, is provided.

The register address controller includes a second status register that determines whether or not a starting address of a first register that is set by the starting address setting unit overlaps an address set on another register.

The present invention provides a register address controller comprising a register on which address information and bit information are to be set; and an address bit information setting unit configured to set the address information and the bit information on the register.

In the register address controller, the address bit information setting unit uniquely sets the bit information.

The register address controller includes a lock control unit that prohibits making of a write access to the register.

The present invention can provide a semiconductor integrated circuit and a register address controller that enable use of software produced by an existing semiconductor integrated circuit even when functional additions and corrections are made to the existing semiconductor integrated circuit and that enable enhancement of CPU performance.

### BRIEF DESCRIPTION OF THE DRAWINGS

FIG. 1 shows a schematic diagram showing a semiconductor integrated circuit of a first embodiment.

FIG. 2 shows a schematic diagram showing a semiconductor integrated circuit of a second embodiment.

FIG. 3 shows a schematic diagram of a register address controller of a third embodiment.

FIG. 4 shows a schematic diagram of a register address controller of a fourth embodiment.

FIG. 5 shows a schematic diagram of a register address controller of a fifth embodiment.

FIG. 6 shows a view showing the register address controller of the fifth embodiment in which an address of a register and a bit position are set in an address bit information setting unit.

FIG. 7 shows a schematic diagram of a register address controller of a sixth embodiment.

FIG. 8 shows a schematic diagram of a register address controller of a seventh embodiment.

FIG. 9 shows a schematic diagram of a register address controller of an eighth embodiment.

### DESCRIPTION OF THE PREFERRED EMBODIMENTS

Embodiments of the present invention are hereunder described by reference to the drawings.

### First Embodiment

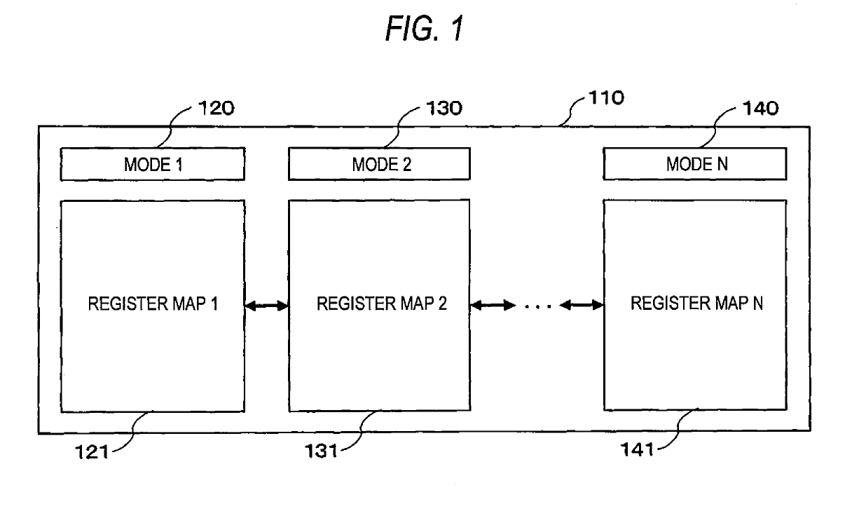

FIG. 1 is a schematic diagram showing a semiconductor integrated circuit of a first embodiment. As shown in FIG. 1, a semiconductor integrated circuit 110 of a first embodiment has register maps 1 to N (121, 131, and 141) having different address bit assignments in order to determine correspondence between a register and addresses for specifying the register in each of modes 1 to N (120, 130, and 140). Any one of the register maps 1 to N (121, 131, and 141) is selected in correspondence with a corresponding mode (120, 130, or 140).

In the semiconductor integrated circuit 110 of the embodiment, a register map 1 (121) is identical with the existing semiconductor integrated circuit, and a register map 2 (131) is a register map produced by making a functional addition or correction to the existing semiconductor integrated circuit. Therefore, when the mode 1 (120) is set, the software prepared by means of the existing semiconductor integrated circuit can be used intact without involvement of an increase in the number of steps of designing software. When a register map that disables an access to a register intended for using a specific function is taken as a register map N (141), the mode of the semiconductor integrated circuit 110, such as a metal fuse, is set to a mode N (140), whereby a semiconductor integrated circuit limited to a specific function can be produced.

It may also be possible to set initial values of address information and bit information in a plurality of modes and switch the plurality of register maps according to the initial values of the respective modes.

The semiconductor integrated circuit 110 of the present embodiment can select, according to a mode, either the register map using without modification the software prepared by the existing semiconductor integrated circuit or the register map including a functional addition or correction. Therefore, the software prepared by the existing semiconductor integrated circuit can be used intact without involvement of an increase in the number of steps of designing software.

### Second Embodiment

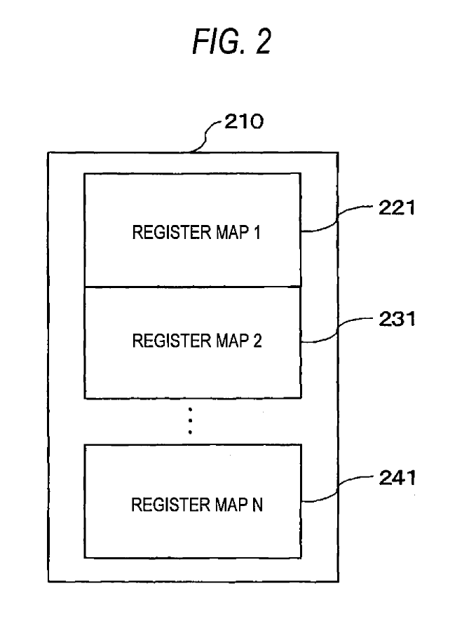

FIG. 2 is a schematic diagram showing a semiconductor integrated circuit of a second embodiment. As shown in FIG. 2, a semiconductor integrated circuit 210 of the second embodiment has register maps 1 to N (221, 231, and 241) arranged respectively in different address spaces. Arranging the register maps 1 to N (221, 231, and 241) in different address spaces makes it possible to simultaneously use a plurality of register maps.

In the semiconductor integrated circuit 210 of the present embodiment, for instance the register map 1 (221) is identical with a register map of an existing semiconductor integrated circuit, and a register map 2 (231) is a register map generated as a result of a functional addition or correction being made to the existing semiconductor integrated circuit. Therefore, the software prepared by the existing semiconductor integrated circuit can be used intact without involvement of an increase in the number of steps of designing software. Further, the register map 1 (221) identical with the register map of the existing semiconductor integrated circuit and the register map 2 (231) subjected to functional additions or corrections can be simultaneously used. Therefore, it becomes possible to design software including functional additions or corrections can be designed by making additions or corrections to the software prepared by the existing semiconductor integrated circuit.

The semiconductor integrated circuit 210 of the present embodiment makes it possible to divert the software prepared by the existing semiconductor integrated circuit to a semiconductor integrated circuit to be newly designed. Further, it becomes possible to design software including additional functions or corrected functions.

### Third Embodiment

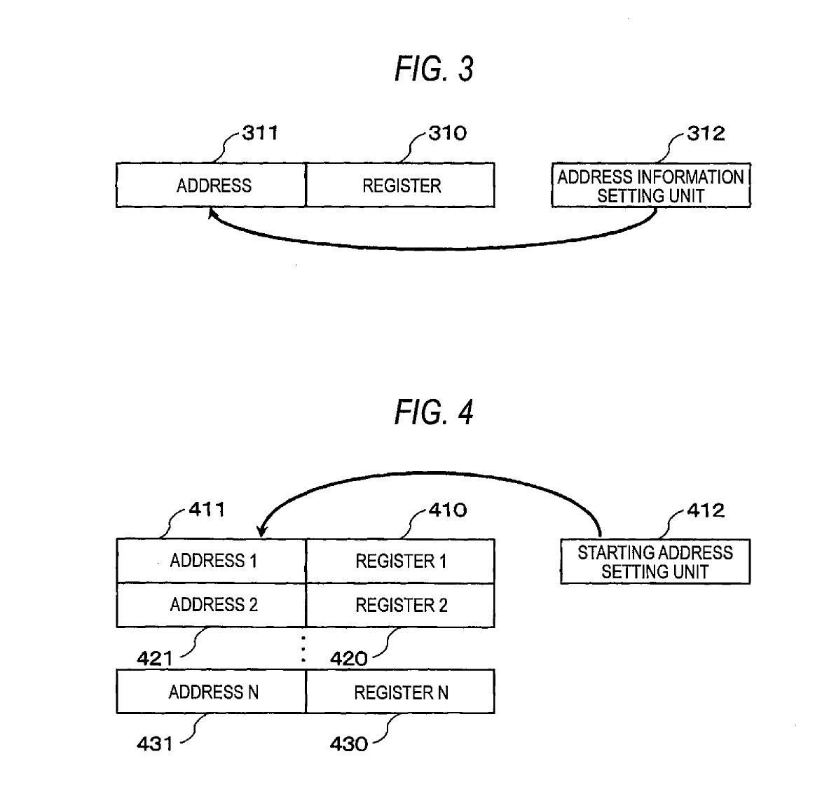

FIG. 3 is a schematic diagram showing a register address controller of a third embodiment. As shown in FIG. 3, a register address controller of the third embodiment has a register 310 and an address information setting unit 312 that sets address information in the register 310. In the embodiment shown in FIG. 3, an address 311 is set in the register 310.

The address information setting unit 312 arbitrarily sets address information in the register 310. Therefore, an address of an additional register can be freely set in the same register map as that of the existing semiconductor integrated circuit. Consequently, software prepared by the semiconductor integrated circuit can be intact diverted to a semiconductor integrated circuit to be newly designed without involvement of an increase in the number of steps of designing software. Moreover, it is possible to design software including additional functions or corrected functions by making additions or corrections to the software prepared by the existing semiconductor integrated circuit.

The register address controller of the present embodiment makes it possible for a semiconductor integrated circuit to be newly designed to use intact the software prepared by the existing semiconductor integrated circuit without involvement of an increase in the number of steps of designing software. Moreover, software including additional functions or corrected functions can be designed.

### Fourth Embodiment

FIG. 4 is a schematic diagram showing a register address controller of a fourth embodiment. As shown in FIG. 4, a register address controller of the fourth embodiment includes registers 1 to N (411, 421, and 431) and a starting address setting unit 412 that sets address information on a register 1 (420). In the embodiment shown in FIG. 4, an address 2 (421) to an address N (431) are set on an address 2 (421) to an address N (431), respectively. The addresses 2 to N (421, and 431) sequentially follow the address 1 (411).

The starting address setting unit 412 can arbitrarily set a starting address on each of the plurality of registers. Therefore, an address of an added register can be freely set on the register map identical with the register map of the existing semiconductor integrated circuit. Consequently, the software prepared by the existing semiconductor integrated circuit can be diverted intact to a semiconductor integrated circuit to be newly designed without involvement of an increase in the number of steps of designing software. Moreover, it is possible to design software including additional functions or corrected functions by making additions or corrections to the software prepared by the existing semiconductor integrated circuit.

The register address controller of the present embodiment makes it possible for a semiconductor integrated circuit to be newly designed to use intact the software prepared by the existing semiconductor integrated circuit without involvement of an increase in the number of steps of designing software. Moreover, software including additional functions or corrected functions can be designed.

### Fifth Embodiment

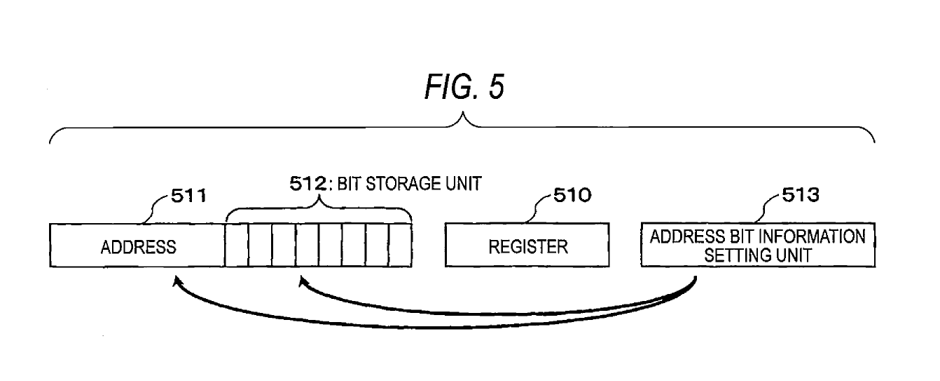

FIG. 5 is a schematic diagram showing a register address controller of a fifth embodiment. As shown in FIG. 5, a register address controller of the fifth embodiment includes a register 510 and an address bit information setting unit 513 that sets address information and bit information on the register 510. In the embodiment shown in FIG. 5, an address 511 is set on the register 510.

The address bit information setting unit 513 arbitrarily sets address information and bit information on the register 510. For this reason, an address of an added register can be freely set in the register map identical with that of the existing semiconductor integrated circuit. Therefore, it is possible to use intact the software prepared by the existing semiconductor integrated circuit without involvement of an increase in the number of steps of designing software. Moreover, it is possible to design software including additional functions or corrected functions by making additions or corrections to the software prepared by the existing semiconductor integrated circuit.

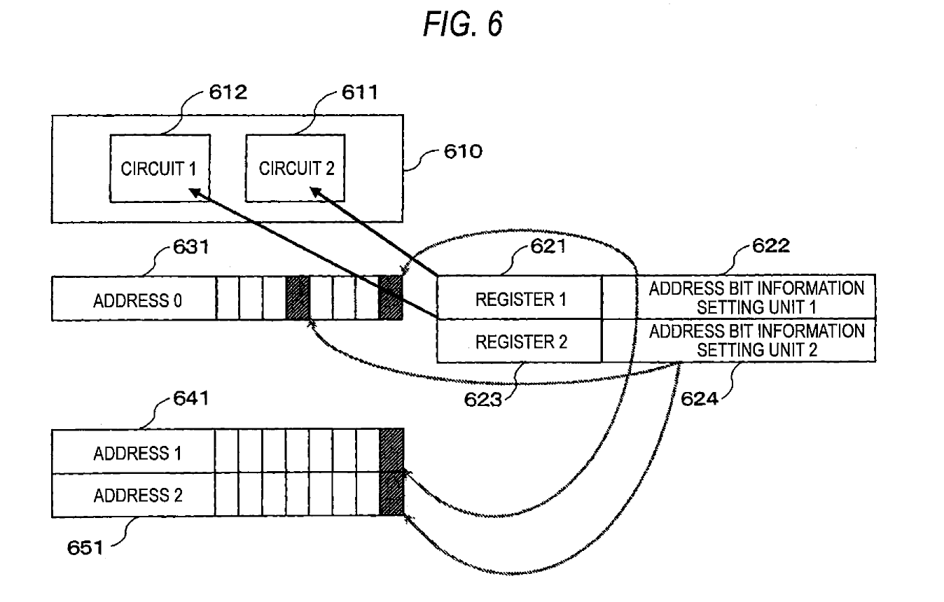

FIG. 6 is a view showing an embodiment of the semiconductor integrated circuit in which an address of a register and a bit position are set in the address bit information setting unit. As shown in FIG. 6, a semiconductor integrated circuit 610 has a circuit 1 (611) and a circuit 2 (612).

A register 1 (621) for controlling the circuit 1 (611) sets address information and bit information used by the address bit information setting unit 1 (622) to specify the register 1 (621). The register 2 (623) for the circuit 2 (612) sets address information and bit information used by the address bit information setting unit 2 (624) to specify the register 2 (623).

When the circuit 1 (611) and the circuit 2 (612) in the semiconductor integrated circuit 610 must be simultaneously controlled, an address 0 (631) is set in the address bit information setting section 1 (622), and a bit position of the 0^{th} bit is set. Further, the address 0 (631) is set in the address bit information setting unit 2 (624), and a bit position of the 4^{th} bit is set.

When the circuit 1 (611) and the circuit 2 (612) in the semiconductor integrated circuit 610 must be separately controlled, an address 1 (641) is set in the address bit information setting unit 1 (622), and the bit position of the 0^{th} bit is set. An address 2 (651) is set on the address bit information setting unit 2 (624), and the bit position of the 0^{th} bit is set.

According to the embodiment, an address and a bit position can be set for each bit of a register. Therefore, a register to be used for another task is set to a different address, whereby exclusiveness of the register access can be assured. Moreover, a register required to execute a task is selected and set to one address, so that a register access time can be minimized. As a consequence, performance of a CPU is enhanced.

The register address controller of the present embodiment makes it possible for a semiconductor integrated circuit to be newly designed to use intact the software prepared by the existing semiconductor integrated circuit. Further, it becomes possible to design software including an additional function or a corrected function. It is further possible to assure exclusiveness of a register access, and a register access time can be minimized. As a consequence, CPU performance is enhanced.

### Sixth Embodiment

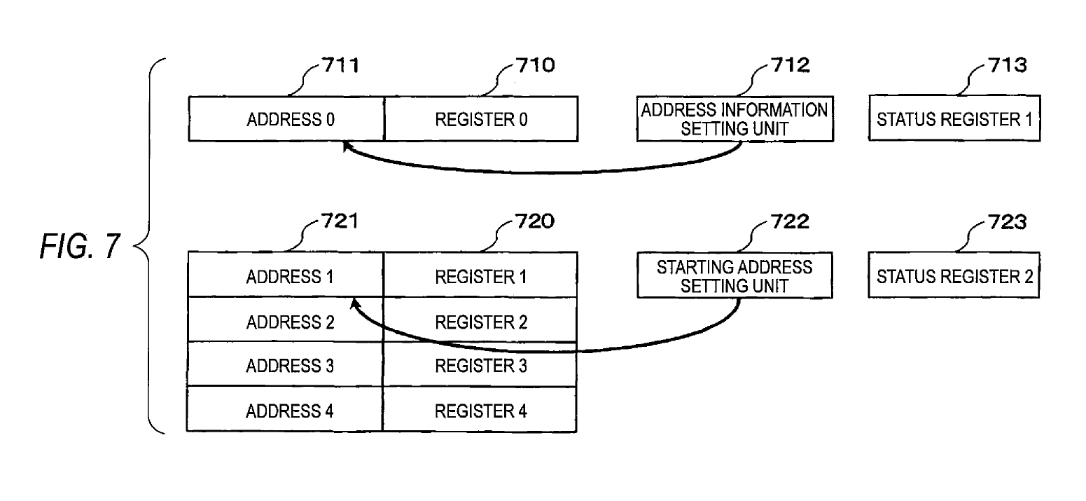

FIG. 7 is a schematic diagram showing a register address controller of a sixth embodiment. As shown in FIG. 7, the register address controller of the sixth embodiment has registers 0 to 4 (710 and 720); an address information setting unit 712 that sets address information on a register 0 (710); a status register 1 (713) that shows a result of a determination made as to whether or not a value set by the address information setting unit 712 has an error; a starting address setting unit 722 that sets address information on a register 1 (720); and a status register 2 (723) that shows a result of a determination made as to whether or not a value set by the starting address setting unit 722 has an error. Addresses 2 to 4 assigned to the registers 2 to 4 sequentially follow the address 1 (711).

Operation of the status register 1 (713) and operation of the status register 2 (723) are now described. For instance, when an address of 2 is set on the address information setting unit 712 and when an address of 1 is set on the starting address setting unit 722, an address of 2 is set in the address storage unit 0 (711), and an address of 2 is also set in the address storage unit 2. Therefore, an error takes place, and the status register 1 (713) shows an error status. Thus, it is possible to prevent the address information setting unit 712 to set an erroneous value.

The same also applies to operation of the status register 2 (723). It is possible to determine whether or not the value set by the starting address setting unit 722 includes an error, by checking an error status. Therefore, it is possible to prevent the starting address setting unit 722 to set an erroneous value.

The register address controller of the present embodiment makes it possible for a semiconductor integrated circuit to be newly designed to use intact the software prepared by the existing semiconductor integrated circuit without involvement of an increase in the number of steps of designing software. Moreover, software including additional functions or corrected functions can be designed. It is also possible to prevent the address information setting unit and the starting address setting unit from setting erroneous values.

### Seventh Embodiment

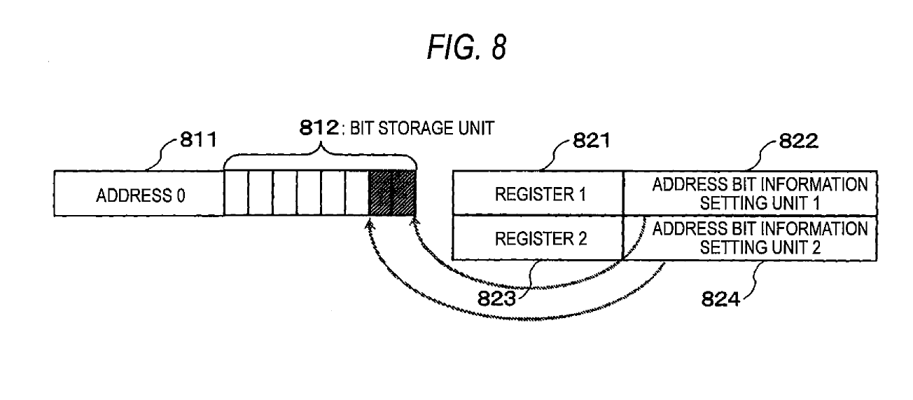

FIG. 8 is a schematic diagram showing a register address controller of a seventh embodiment. As shown in FIG. 8, the register address controller of the seventh embodiment has registers 1, 2 (821, 823); an address information setting unit 1 (822) that sets address information and bit information on the register 1 (821); and an address information setting unit 2 (824) that sets address information and bit information on the register 2 (823).

When the address information setting unit 1 (822) sets an address 0 (811) in the register 1 (821) and when the address information setting unit 2 (824) sets an address 0 (811) in the register 2 (823), bit information is uniquely set by adoption of conditions, like setting an address in a register in sequence from a lower bit.

Therefore, when compared with the sixth embodiment, a circuit scale for setting bit information can be reduced. Moreover, an address can be set on a per-bit of a register. Therefore, setting a register to be used for another task at a different address, whereby exclusiveness of a register access can be assured. Further, a register required to execute a task is selected, and the thus-selected register is set to one address, whereby a register access time can be minimized. As a consequence, CPU performance is enhanced.

The register address controller of the present embodiment makes it possible for a semiconductor integrated circuit to be newly designed to use intact the software prepared by the existing semiconductor integrated circuit without involvement of an increase in the number of steps of designing software. Moreover, software including additional functions or corrected functions can be designed. It is also possible to assure exclusiveness of a register access and minimize a register access time. As a consequence, CPU performance is enhanced.

### Eighth Embodiment

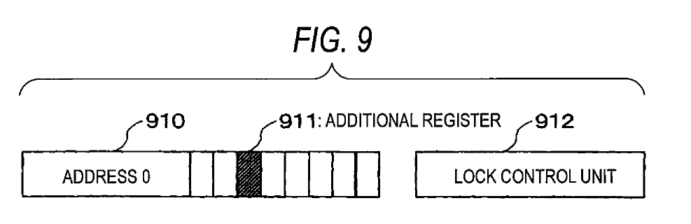

FIG. 9 is a schematic diagram showing a register address controller of an eighth embodiment. As shown in FIG. 9, the register address controller of the eighth embodiment has an addition register 911 and a lock control unit 912 that controls whether to enable or disable write access to the additional register 911. In the embodiment shown in FIG. 9, an address 0 (910) is set, in an additional register 011. When a new function is added to a register map of an existing semiconductor integrated circuit, the lock control unit 912 can lock write access to the additional register 911.

The register address controller of the present embodiment makes it possible for a semiconductor integrated circuit to be newly designed to use intact the software prepared by the existing semiconductor integrated circuit without involvement of an increase in the number of steps of designing software.

Although the present invention has been described in detail and by reference to the specific embodiment, it is manifest to those skilled in the art without departing the spirit and scope of the present invention.

On the occasion of designing of a semiconductor integrated circuit, the semiconductor integrated circuit and the register address controller of the present invention make it possible to use software prepared by an existing semiconductor integrated circuit even when there is a functional addition or correction and that can enhance CPU performance.

The disclosure of Japanese Patent Application No 2008-294310 filed on Nov. 18, 2008, and PCT Application PCT/JP2009/005614 filed on Oct. 23, 2009 including specification, drawings, and claims is incorporated herein by reference in its entirely.

What is claimed is:

1. A semiconductor integrated circuit, comprising:
a register map that makes correspondence between a register to which a CPU accesses and an address which specifies the register;
wherein the register map includes a plurality of register maps in which assignments of address bits are rearranged in correspondence with each of a plurality of modes; and
wherein any of the register maps is selected from the plurality of register maps according to the respective modes.

2. The semiconductor integrated circuit according to claim 1, wherein:
the plurality of register maps are arranged respectively in different address spaces, and the plurality of register maps are simultaneously used.

3. The semiconductor integrated circuit according to claim 1, wherein:
an initial value of address information and an initial value of bit information are set on each of the plurality of modes; and
the register map is switched according to initial values of the respective modes.

4. A register address controller, comprising:
a register where address information is to be set; and
an address information setting unit configured to set the address information on the register.

5. The register address controller according to claim 4, further comprising a starting address setting unit configured to set a starting address of the address information on the register.

6. The register address controller according to claim 4, wherein:
the register is provided in numbers, and
a first status register that determines whether or not an address of a first register that is set by the address information setting unit overlaps an address that is set on another register, is provided.

7. The register address controller according to claim 5, further comprising a second status register that determines whether or not a starting address of a first register that is set by the starting address setting unit overlaps an address set on another register.

8. A register address controller comprising:
a register on which address information and bit information are to be set; and
an address bit information setting unit configured to set the address information and the bit information on the register.

9. The register address controller according to claim 8, wherein the address bit information setting unit uniquely sets the bit information.

10. The register address controller according to claim 4, further comprising a lock control unit configured to prohibit making of a write access to the register.

11. The register address controller according to claim 5, further comprising a lock control unit configured to prohibit making of a write access to the register.

12. The register address controller according to claim 6, further comprising a lock control unit configured to prohibit making of a write access to the register.

13. The register address controller according to claim 7, further comprising a lock control unit configured to prohibit making of a write access to the register.

14. The register address controller according to claim 8, further comprising a lock control unit configured to prohibit making of a write access to the register.

15. The register address controller according to claim 9, further comprising a lock control unit configured to prohibit making of a write access to the register.
